(19) United States
(12) Patent Application Publication
(10) Pub. No.: US 2015/0379461 A1
(43) Pub. Date: Dec. 31, 2015

(54) CHANNEL ASSORTMENT DECISION ENGINE

(71) Applicant: Wal-Mart Stores, Inc., Bentonville, AR (US)

(72) Inventors: Anton Valkov, San Francisco, CA (US); Arash Asadi-Shahmirzadi, San Bruno, CA (US); Jagtej Bewli, San Mateo, CA (US)

(21) Appl. No.: 14/318,448

(22) Filed: Jun. 27, 2014

(51) Int. Cl. G06Q 10/08; G06Q 30/02

(52) U.S. Cl. CPC G06Q 10/087; G06Q 30/0202

(57) ABSTRACT

A method of limiting cross-channel splits in a supply chain network based at least in part on an additional distinct item capacity of a first channel. The method can include determining a target order set from historical order data, which can include orders each having at least one first item that was fulfilled from the first channel and at least one second item that was fulfilled from a second channel in the supply chain network that is different from the first channel. The method also can include determining, for each order of the target order set, a non-owned item combination, which can include distinct items that were not fulfilled from the first channel when the order was fulfilled. The method further can include determining a non-owned item combination set and a split item set. The method also can include determining, for each of the non-owned item combinations, a combination profit. The method further can include determining a selected set of the distinct items that maximizes a payoff of the selected set of the distinct items.

### TECHNICAL FIELD

This disclosure relates generally to product distribution systems, and relates more particularly to managing product assortment at distribution centers in a supply chain network.

### BACKGROUND

Online retail has become mainstream, which has allowed customers to order an increasing number of products online and receive direct shipments of the items they order. These products are shipped from supply chain channels, which are sources, distribution centers, or warehouses containing sets of items. Online retailers generally have a network of channels to fulfill orders. A supply chain network is a collection of channels having a fulfillment mechanism. Generally, some of the channels in the network are distribution centers that are owned by the online retailer (“owned distribution centers”), and at least some of the other channels are owned by a vendor. Because the owned distribution centers have limited capacity and the number of items sold by online retailers continues to increase, some of the products ordered by customers are shipped to the customers directly from vendor channels rather than all products being shipped from the owned distribution centers.

When an online order for multiple items is fulfilled from multiple different channels (such as when the order includes an item housed at an owned distribution center and an item housed at a vendor channel), the order may be split into multiple packages shipped directed to the customer from the different channels, known as a “cross-channel split,” or simply a “split.” The problem of reducing splits in a supply chain network has become increasingly important to both customers and online retailers as the supply chain network has grown increasingly large and complex. Customers generally have a strong preference to receive all ordered items in a single package. Moreover, shipping multiple packages increases shipping and transportation costs to the online retailer.

In order to decrease splits in a supply chain network, online retailers may attempt to co-locate items that are often ordered together, known as affinity items, in an owned distribution center. For example, iPads and iPad covers are affinity items that are often housed together at an owned distribution center. An owned distribution center, however, has capacity limitations, which can limit the number of items that can be housed at the owned distribution center. Known heuristic algorithms for minimizing split are suboptimal. For example, a sales velocity item ranking approach ranks the top-selling items and ships as many of the top-selling items as possible to the owned distribution center. Another suboptimal approach, known as split participation item ranking, ranks the frequencies of items that have occurred in splits and moves the highest-ranked items to the owned distribution center.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of an exemplary online retail system, portions of which can be employed for limiting cross-channel splits, according to an embodiment;

FIG. 4 illustrates a flow chart for an exemplary method of limiting cross-channel splits in a supply chain network, according to an embodiment; and

FIG. 5 illustrates a block diagram of an example of an inventory system, according to the embodiment of FIG. 3.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments include a method of limiting cross-channel splits in a supply chain network based at least in part on an additional distinct item capacity (t) of a first channel in the supply chain network. The method can be implemented at least partially via execution of computer instructions configured to run at one or more processing modules and configured to be stored at one or more non-transitory memory storage modules. The method can include determining via the one or more processing modules a target order set from historical order data. The target order set can include orders each having at least one first item that was fulfilled from the first channel and at least one second item that was fulfilled from a second channel in the supply chain network that is different from the first channel. The method also can include determining via the one or more processing modules, for each order of the target order set, a non-owned item combination (C). The non-owned item combination (C) can include distinct items (i) that were not fulfilled from the first channel when the order was fulfilled. The method further can include determining via the one or more processing modules a non-owned item combination set (S) and a split item set (I). Each of the non-owned item combinations (C) can be a member of the non-owned item combination set (S). Each of the distinct items (i) in each of the non-owned item combinations (C) can be a member of the split item set (I). The method also can include determining via the one or more processing modules, for each of the non-owned item combinations (C), a combination profit (p_{C}). The method further can include determining via the one or more processing modules a selected set of the distinct items (T) that maximizes a payoff of the selected set of the distinct items (P(T)), such that P(T)=I_{CεS and C⊂T} p_{C}. The selected set of the distinct items (T) can be a subset of the split item set (I). A quantity of the distinct items in the selected set of the distinct items (T) can be less than or equal to the additional distinct item capacity (t).

A number of embodiments include a system for limiting cross-channel splits in a supply chain network based at least in part on an additional distinct item capacity (t) of a first channel in the supply chain network. The system can include one or more processing modules and one or more non-transitory memory storage modules storing computing instructions configured to run on the one or more processing modules. The computing instructions can perform the act of determining via the one or more processing modules a target order set from historical order data. The target order set can include orders each having at least one first item that was fulfilled from the first channel and at least one second item that was fulfilled from a second channel in the supply chain network that is different from the first channel. The computing instructions also can perform the act of determining via the one or more processing modules, for each order of the target order set, a non-owned item combination (C). The non-owned item combination (C) can include distinct items (i) that were not fulfilled from the first channel when the order was fulfilled. The computing instructions further can perform the act of determining via the one or more processing modules a non-owned item combination set (S) and a split item set (I). Each of the non-owned item combinations (C) can be a member of the non-owned item combination set (S). Each of the distinct items (i) in each of the non-owned item combinations (C) can be a member of the split item set (I). The computing instructions also can perform the act of determining via the one or more processing modules, for each of the non-owned item combinations (C), a combination profit (p_{C}). The computing instructions further can perform the act of determining via the one or more processing modules a selected set of the distinct items (T) that maximizes a payoff of the selected set of the distinct items (P(T)), such that P(T)=Σ_{CεS and C⊂T}p_{C}. The selected set of the distinct items (T) can be a subset of the split item set (I). A quantity of the distinct items in the selected set of the distinct items (T) can be less than or equal to the additional distinct item capacity (t).

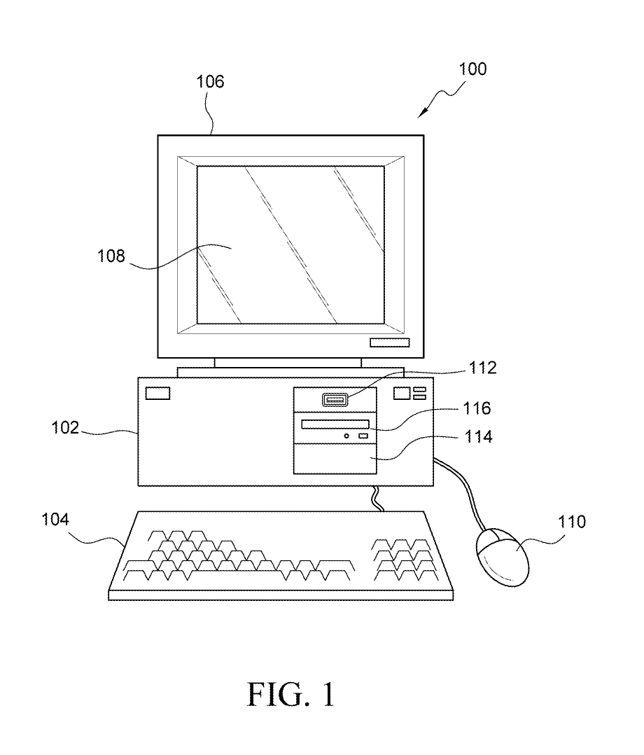

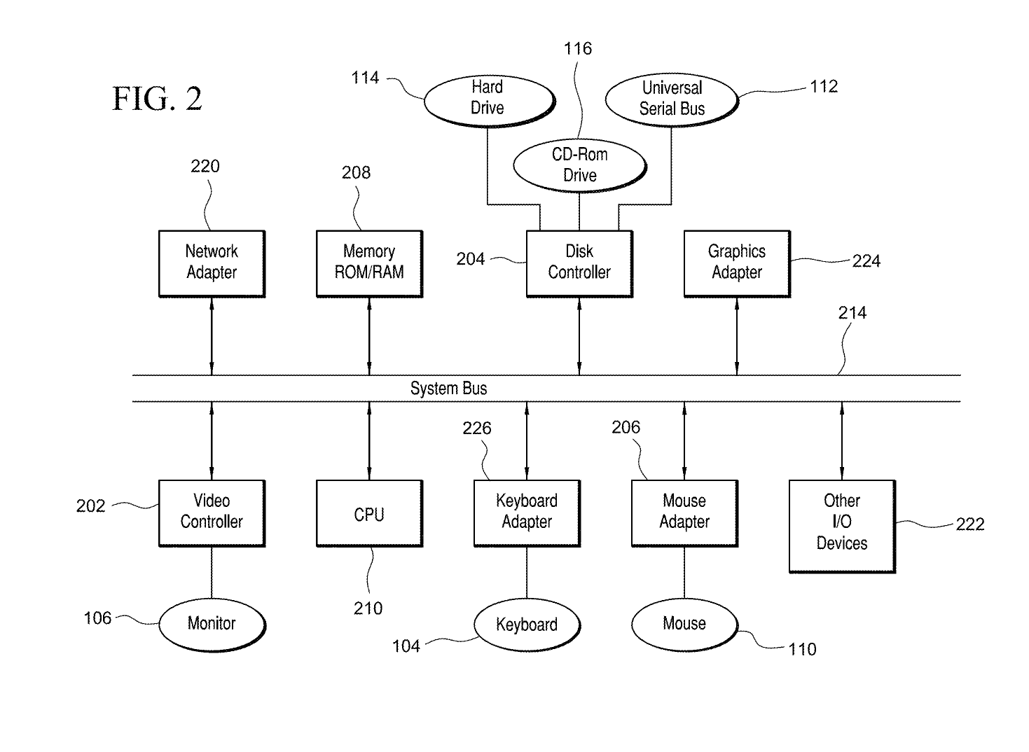

Turning to the drawings, FIG. 1 illustrates an exemplary embodiment of a computer system 100, all of which or a portion of which can be suitable for implementing the techniques described herein. As an example, a different or separate one of a chassis 102 (and its internal components) can be suitable for implementing the techniques described herein. Furthermore, one or more elements of computer system 100 (e.g., a refreshing monitor 106, a keyboard 104, and/or a mouse 110, etc.) can also be appropriate for implementing the techniques described herein. Computer system 100 comprises chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 comprises both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can comprise microcode such as a Basic Input-Output System (BIOS). In some examples, the one or more memory storage units of the various embodiments disclosed herein can comprise memory storage unit 208, a USB-equipped electronic device, such as, an external memory storage unit (not shown) coupled to universal serial bus (USB) port 112 (FIGS. 1-2), hard drive 114 (FIGS. 1-2), and/or CD-ROM or DVD drive 116 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 and the circuit boards inside chassis 102 (FIG. 1) are not discussed herein.

When computer system 100 in FIG. 1 is running, program instructions stored on a USB-equipped electronic device connected to USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out at least part of the techniques described herein.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

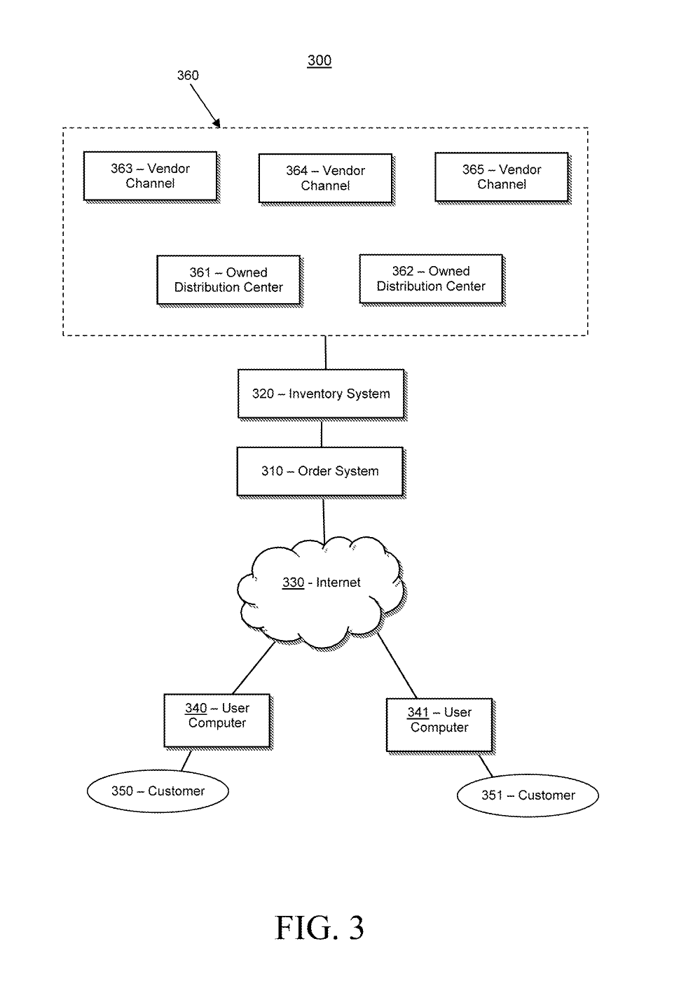

Turning ahead in the drawings, FIG. 3 illustrates a block diagram of an exemplary online retail system 300, portions of which can be employed for limiting cross-channel splits, according to an embodiment. Online retail system 300 is merely exemplary of a system in which an online retailer can receive and fulfil online orders, and embodiments of the online retail system and elements thereof are not limited to the embodiments presented herein. The online retail system and elements thereof can be employed in many different embodiments or examples not specifically depicted or described herein. In some embodiments, certain elements or modules of online retail system 300 can perform various procedures, processes, and/or activities. In other embodiments, the procedures, processes, and/or activities can be performed by other suitable elements or modules of online retail system 300.

In a number of embodiments, online retail system 300 can include a supply chain network 360. In various embodiments, supply chain network 360 can include one or more channels, such as one or more owned distribution centers (e.g., 361, 362), one or more vendor channels (e.g., 363, 364, 365), and/or other suitable channels, such as stores with order-fulfillment capabilities (not shown). Owned distribution centers (e.g., 361, 362) are owned, operated, and/or controlled by the online retailer. Vendor channels (e.g., 363, 364, 365) are owned, operated, and/or controlled by third-parties, such as drop-ship vendors.

In some embodiments, online retail system 300 can include an order system 310 and/or an inventory system 320. Inventory system 320 and/or order system 310 can each be a computer system, such as computer system 100 (FIG. 1), as described above, and can each be a single computer, a single server, or a cluster or collection of computers or servers, or a cloud of computers or servers. In some embodiments, inventory system 320 can track the items (e.g., stock keeping units (SKUs)) which can be ordered through the online retailer and which can be housed at one or more of the channels (e.g., 361-365) of supply chain network 360. In some embodiments, inventory system 320 can track items for more than one owned distribution center, such as both owned distribution center 361 and owned distribution center 362. In other embodiments, online retail system 300 can include an inventory system (e.g. inventory system 320) for each owned distribution center (e.g., 361, 362).

In many embodiments, inventory system 320 can be in data communication with order system 310. In certain embodiments, inventory system 320 and order system 310 can be separate systems. In other embodiments, inventory system 320 and order system 310 can be a single system. In various embodiments, order system 320 can be in data communication through Internet 330 with user computers (e.g., 340, 341). User computers 340-341 can be desktop computers, laptop computers, smart phones, tablet devices, and/or other endpoint devices, which can allow customers (e.g., 350-351) to access order system 320 through Internet 330. In various embodiments, order system 320 can host one or more websites, such as through one or more web servers. For example, order system 320 can host an eCommerce website that can allow customers (e.g., 350, 351) to browse and/or search for products, to add products to an electronic shopping cart, and/or to purchase products by completing an online order, in addition to other suitable activities.

In some instances, an online order submitted by a customer (e.g., 350, 351) can result in a cross-channel split. As an example, customer 350 can use user computer 340 to access order system 310 to complete an online order for three separate items sold through the online retailer. Of the three items, for example, only the first two items are housed at owned distribution center 361. The third item, which is not housed at owned distribution center 361, can be located at vendor channel 363. In order to deliver the three items to customer 350 in an acceptable time frame, the online retailer ships the first two items directly to customer 350 from owned distribution center 351, and pays for the third item to be shipped directly to customer 350 from vendor channel 363. In other examples, a cross-channel split can result from an order for one or more items housed at an owned distribution center, such as owned distribution center 361 or owned distribution center 362, and for one or more items that are not housed at an owned distribution center (e.g., 361, 362), but that are housed at one or more other channels, such as vendor channel 363, vendor channel 364, and/or vendor channel 365. In yet another example, a cross-channel split can result from an order for one or more items housed at an owned distribution center, such as owned distribution center 361, and for one or more items that are not housed at owned distribution center 361, but are housed at one or more other channels, such as owned distribution center 362, vendor channel 363, vendor channel 364, and/or vendor channel 365.

In many embodiments, cross-channel splits can be reduced by relocating items in vendor channels (e.g., 363, 364, 365) to owned distribution centers (e.g., 361, 362), which can advantageously satisfy customers who prefer to receive all ordered items in a single shipment and/or can beneficially reduce costs to the online retailer. For example, cross-channel splits generally result in multiple packaging costs and multiple shipping costs, which can be reduced to a single packaging cost and a single shipping cost when all ordered items are housed at an owned distribution center (e.g., 361, 362). That is because the cost of relocating the supply of an item (e.g., each article of a particular SKU) to an owned distribution center (e.g., 361, 362) from a vendor channel (e.g., 363, 364, 365), such as by bulk shipping in a freight truck, is generally less than the total cost of individually packaging and individually shipping each article in the supply of the item to customers (e.g., 350, 351).

Distribution centers (e.g., 361, 362) have capacity limitations, however, and generally cannot house every item (e.g., SKU) that is available for sale through the online retailer. As such, the assortment of distinct items (e.g., SKUs) at the distribution centers (e.g., 361, 362) can affect the number of cross-channel splits. In many embodiments, inventory system 320 can determine which items (e.g., SKUs) to relocate from vendor channels (e.g., 363, 364, 365) to owned distribution centers (e.g., 361, 362). In many embodiments, inventory system 320 can determine an additional distinct item capacity (represented as t) of an owned distribution center (e.g., 361, 362), which can be the number of additional distinct items (e.g. SKUs) that can be housed at the owned distribution center (e.g., 361, 362). For example, inventory system 320 can determine that owned distribution center 361 has an additional distinct item capacity (t) that can allow for housing 20 additional SKUs (e.g., a supply for each of the 20 SKUs).

Given the additional distinct item capacity t of an owned distribution center (e.g., 361, 362), in many embodiments inventory system 320 can determine which additional items should be relocated to the owned distribution center (e.g., 361, 362) from the vendor channels (e.g., 363, 364, 365) to minimize the number of cross-channel splits in supply chain network 360 and/or at individual owned distribution centers (e.g., 361, 362). In several embodiments, the assortment determination can be based on historical order data, such as recent past sales data. For example, the historical order data can be online orders for the past 60 days, such as through order system 310. In other embodiments, the historical order data can be for more than or less than 60 days. Each online order that resulted in a cross-channel split can be an opportunity to reduce the number of splits. In many embodiments, inventory system 320 can determine a target order set from the historical order data. The target order set can be the online orders having cross-channel splits. Each order in the target order set can contain at least one item that was shipped from an owned distribution center and at least one item that was shipped from a different channel. For example, each order in the target order set can include at least one item that was fulfilled from a channel in supply chain network 360, such as an owned distribution center (e.g., 361, 362), and at least one item that was fulfilled from a different channel in supply chain network 360, such as a vendor channel (e.g., 363, 364, 365).

For each order O in the target order set, let a non-owned item combination, C, be the set of distinct items in O that were not shipped from an owned distribution center (e.g., 361, 362). Let a non-owned item combination set, S, be the set of all non-owned item combinations of all cross-channel split orders in the target order set. Let a split item set, I, be the set of all items appearing in any non-owned item combination C in the non-owned item combination set S. It is possible that multiple split orders in the target order set can have the same non-owned item combination C. In many embodiments, inventory system 320 can determine each of the non-owned item combinations C, the non-owned item combination set S, and the split item set I.

In a number of embodiments, for each non-owned item combination C, inventory system 320 can determine a combination profit, p_{C}. In several embodiments, the combination profit p_{C} for a particular non-owned item combination C can be the number of cross-channel split orders that are have that particular non-owned item combination C. In other embodiments, combination profit p_{C} can be the profit to be gained for the online retailer by relocating all of the items in the non-owned item combination C to owned distribution centers (e.g., 361, 362). For example, the profit can be based on a difference between a combination of the packaging cost and individual shipping cost, and the bulk shipping cost of the distinct items in non-owned item combination C. In other embodiments, additional and/or other suitable business metrics can be used to determine the combination profit p_{C}.

By moving all items in any of the non-owned item combination C of the non-owned item combination set S to an owned distribution center (e.g., 361, 362), we eliminate cross-channel splits for that non-owned item combination C, as orders associated with the non-owned item combination C can be fully fulfilled from the owned distribution center (e.g., 361, 362). When the combination profit p_{C} is the number of cross-channel split orders, p_{C} can represent the number of cross-channel split orders that are eliminated based on the relocation of the items in the non-owned item combination C. In many embodiments, inventory system 320 can determine a selected set of distinct items T from the split item set I, or as expressed in set notation, T⊂I. The size of the selected set of distinct items T can be at most equal to the additional distinct item capacity t. In many embodiments, inventory system 320 can calculate a payoff of the selected set of the distinct items, P(T)=Σ_{C⊂T} p_{C}. In several embodiments, inventory system 320 can determine the selected set of distinct items T, T⊂I, with at most t items to be added to owned distribution centers (e.g., 361, 362) so that the selected set of distinct items T limits the maximum possible number of cross-channel splits and/or maximizes the payoff P(T).

As a simple illustration, consider the online order history in Table 1.

TABLE 1
Online order history

| Order Names/Numbers | Items in the Order | | | | | | |
|---|---|---|---|---|---|---|---|
| O₁ | j₁ | j₂ | j₃ | i₁ | | | |
| O₂ | j₁ | | j₃ | i₁ | | | |
| O₃ | j₁ | j₂ | | i₁ | | | |
| O₄ | | j₂ | | | | i₃ | i₄ |
| O₅ | | j₂ | j₃ | i₁ | i₂ | | i₄ |
| O₆ | | | j₃ | i₁ | i₂ | | i₄ |

In the data illustrated in Table 1, j₁, j₂, and j₃ are items that shipped from an owned distribution center (e.g., 361, 362); i₁, i₂, and i₃ are items that shipped from vendor channels (e.g., 363, 364, 365); and owned distribution centers (e.g., 361, 362) are capable of adding two more items, such that the additional distinct item capacity t=2. The target order set is {O₁, O₂, O₃, O₄, O₅, O₆}. The non-owned item combination set S={{i₁}, {i₃,i₄}, {i₁,i₂,i₄}}, and split item set I={i₁,i₂,i₃, i₄}. Assuming for purposes of illustration that the combination profit p_{C} for each non-owned item combination C is $1, the combination profit p_{C} associated with each non-owned item combination C is: p_{{i}_{_{1}}}=$3, p_{{i}_{₃}_{, i}_{₄}_{}}=$1, and p_{{i}_{₁}_{,i}_{₂}_{,i}_{₄}_{}}=$2.

As a mathematical formulation, S_{⊂}Pow(I), where Pow(I) is the power set of I. For each non-owned item combination CεS, let the combination profit p_{C} be the profit associated with non-owned item combination C. We assume that p_{C} is a positive real number. For each set T⊂I, the payoff of T denoted by P(T) is defined as follows:

$$P ( T ) = {\sum }_{C ∈ S and C ⊆ T} {p}_{C} .$$

In other words, P(T) is the sum of the profits associated with the non-owned item combinations C in the non-owned item combination set S in which the distinct items in the non-owned item combinations C are present in the selected set of distinct items T.

The objective is, given an integer number t, to determine which subset of I with size at most t has the greatest payoff. A formulation of the problem can be stated as follows:

$$maximize P ( T ) = {\sum }_{C ∈ S and C ⊆ T} {p}_{C} . \\ subject to \text{:} \\ T ⊆ I \\ \vert T \vert \leq t . \qquad ( 1 )$$

In many embodiments, inventory system 320 can determine the selected set of distinct items T that satisfies formulation 1.

In various embodiments, formulation 1 can be solved using an integer programming formulation. For example, the following notations can be defined to provide the integer programming formulation. A subset T of I is feasible or acceptable if |T|≦t. For any feasible subset T and iεI, let X(i)ε{0,1} be the characteristic function of i with respect to T, which means that if item i is in T then X(i)=1, otherwise X(i)=0. For each non-owned item combination C E S, we define the characteristic function of C with respect to T as Y(C)ε{0,1}, where Y(C)=1 if for all items iεC, X (i)=1, and Y(C)=0 if there exists an item iεC where X(i)=0. In other words, Y(C)=1 if and only if all items in C are present in T. As such, Y(C) satisfies the following inequality:

n×Y(C)≦X(i₁)+X(i₂)+ . . . +X(iₙ). (2)

More generally, for any non-owned item combinations CεS,

$$\vert C \vert \times Y ( C ) \leq {\sum }_{i ∈ C} X ( i ) . \qquad ( 3 )$$

Because any feasible set T is at most t,

$${\sum }_{i ∈ I} X ( i ) \leq t , \qquad ( 4 )$$

where |C| is the number of distinct items in the non-owned item combination C.

The payoff of a feasible set T can be written as follows:

$$P ( T ) = {\sum }_{C ∈ S } {p}_{C} \times Y ( C ) . \qquad ( 5 )$$

Inequalities 3 and 4, and equality 5 can be used to express Formulation 1 as an integer programming formulation, as follows:

$$maximize {\sum }_{C ∈ S} {p}_{C} \times Y ( C ) \\ subject to \text{:} \\ {\sum }_{i ∈ I} X ( i ) \leq t \\ \vert C \vert \times Y ( C ) \leq {\sum }_{i ∈ C} X ( i ) for all C ∈ S \\ X ( i ) ∈ \{ 0 , 1 \} for all i ∈ I \\ Y ( C ) ∈ \{ 0 , 1 \} for all C ∈ S . \qquad ( 6 )$$

Because X(i) and Y(C) are binary, and formulation 6 is linear, the integer programming formulation can be solved in a reasonable amount of time. In many embodiments, inventory system 320 can solve formulation 6 using an optimization solver, such as Gurobi, or another suitable optimization solver. In many embodiments, inventory system 320 can determine the optimal selected set of distinct items T that maximizes the payoff P(T).

As an example of integer programming formulation (6), the example shown in Table 1 and described above can be notated as follows: X(i₁)=x₁, X(i₂)=x₂, X(i₃)=x₃, X(i₄)=x₄, X(i₄)=x₄, Y({i₁})=y₁, Y({i₃,i₄})=y₂, and Y({i₁,i₂,i₄})=y₃. An equivalent integer programming formulation of this example according to Formulation 6 is as follows:
maximize 3y₁+1y₂+2y₃
subject to:

x₁+x₂+x₃+x₄≦2

y₁≦x₁

2y₂≦x₃+x₄

3y₃≦x₁+x₂+x₄

x₁,x₂,x₃,x₄ε{0,1}

y₁,y₂,y₃ε{0,1}. (7)

In many embodiments, inventory system 320 can use an optimization solver to solve integer programming formulation 7, which can be used to determine which distinct items are included in the selected set of distinct items T. For example, if x₁=1, then i₁ should be included in the selected set of distinct items T, and if x₁=0, then i₁ should not be included in the selected set of distinct items T.

After determining the selected set of distinct items T, a supply for each of the distinct items (e.g., SKUs) in the selected set of distinct items T can be relocated to the owned distribution center (e.g., 361, 362) to eliminate future cross-channel splits involving that distinct item.

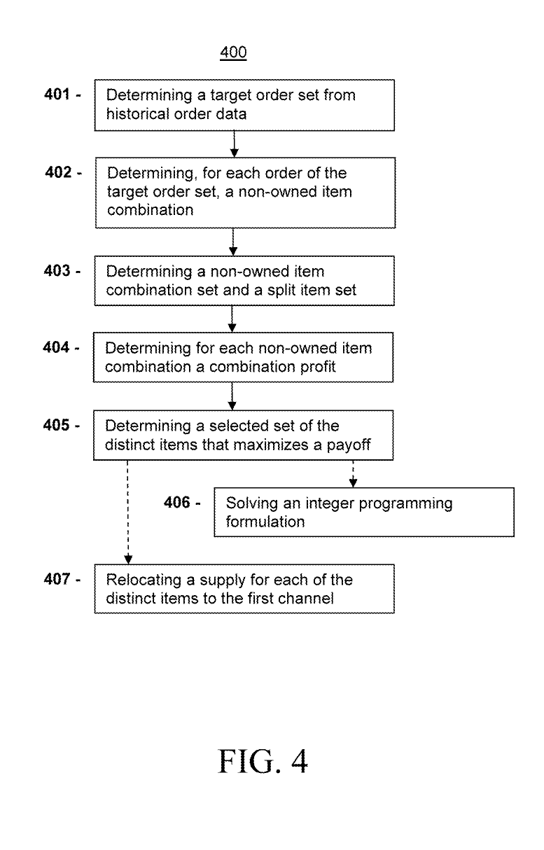

Turning ahead in the drawings, FIG. 4 illustrates a flow chart for a method 400 of limiting cross-channel splits in a supply chain network, according to an embodiment. The supply chain network can be identical or similar to supply chain network 360 (FIG. 3). Method 400 can be based at least in part on an additional distinct item capacity (t) of a first channel in the supply chain network. In some embodiments, the first channel in the supply chain network can be an owned distribution center, such as owned distribution center 361 (FIG. 3) or owned distribution center 362 (FIG. 3). Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In some embodiments, method 400 can be implemented at least partially by inventory system 320 (FIG. 3) and/or order system 310 (FIG. 3).

Referring to FIG. 4, in some embodiments method 400 can include a block 401 of determining a target order set from historical order data. In many embodiments, the target order set can include orders that each have at least one first item that was fulfilled from the first channel and at least one second item that was fulfilled from a second channel in the supply chain network that is different from the first channel. In many embodiments, the second channel in the supply chain network can be a vendor channel, such as vendor channel 363 (FIG. 3), vendor channel 364 (FIG. 3), or vendor channel 365 (FIG. 3). In a number of embodiments, the historical order data can include online orders for the past 60 days. In other embodiments, the historical order data can include online orders from less than 60 days or greater than 60 days.

In a number of embodiments, method 400 can include a block 402 of determining, for each order of the target order set, a non-owned item combination (C). In many embodiments, non-owned item combination (C) can include distinct items (i) that were not fulfilled from the first channel when the order was fulfilled.

In many embodiments, method 400 can include a block 403 of determining a non-owned item combination set (S) and a split item set (I). In several embodiments, each of the non-owned item combinations (C) can be a member of the non-owned item combination set (S). In a number of embodiments, each of the distinct items (i) in each of the non-owned item combinations (C) can be a member of the split item set (I).

In a number of embodiments, method 400 can include a block 404 of determining, for each of the non-owned item combination (C), a combination profit (p_{C}). In some embodiments, the combination profit (p_{C}) for each of the non-owned item combinations can be a quantity of the orders of the target order set having the non-owned item combination. In other embodiments, the combination profit (p_{C}) for each of the non-owned item combinations (C) can be a profit to be gained by adding each of the items in the non-owned item combination (C) to the first channel. For example, the combination profit (p_{C}) for each of the non-owned item combination (C) can be based at least in part on a packaging cost, an individual shipping cost, and/or a bulk shipping cost of the distinct items in non-owned item combination (C).

In many embodiments, method 400 can include a block 405 of determining a selected set of the distinct items (T) that maximizes a payoff of the selected set of the distinct items (P(T)). In several embodiments, P(T)=Σ_{CεS and C⊂T}p_{C}. In a number of embodiments, the selected set of the distinct items (T) can be a subset of the split item set (I). In various embodiments, a quantity of the distinct items in the selected set of the distinct items (T) can be less than or equal to the additional distinct item capacity (t).

In a number of embodiments, block 405 can include a block 406 of determining solving an integer programming formulation. For example, the integer programming formulation can be of the following form:

$$maximize {\sum }_{C ∈ S} {p}_{C} \times Y ( C )$$

$$subject to \text{:}$$

$${\sum }_{i ∈ I} X ( i ) \leq t$$

$$\vert C \vert \times Y ( C ) \leq {\sum }_{i ∈ C} X ( i ) for all C ∈ S$$

$$X ( i ) ∈ \{ 0 , 1 \} for all i ∈ I$$

$$Y ( C ) ∈ \{ 0 , 1 \} for all C ∈ S .$$

In several embodiments, X(i) can be a binary representation of whether each of the distinct items (i) is in the selected set of the distinct items (T). In various embodiments, Y(C) can be a binary representation of whether all of the distinct items (i) in each of the non-owned item combinations (C) are in the selected set of the distinct items (T). In certain embodiments, block 406 can be performed via a conventional optimization solver, as described above.

In many embodiments, method 400 can optionally include a block 407 of relocating a supply for each of the distinct items in the selected set of the distinct items (T) to the first channel. For example, after determining the selected set of the distinct items (T), the online retailer can order a bulk supply of the distinct items (e.g., SKUs) in the selected set of the distinct items (T) to be shipped to one or more of the owned distribution centers (e.g., 361, 362 (FIG. 3)).

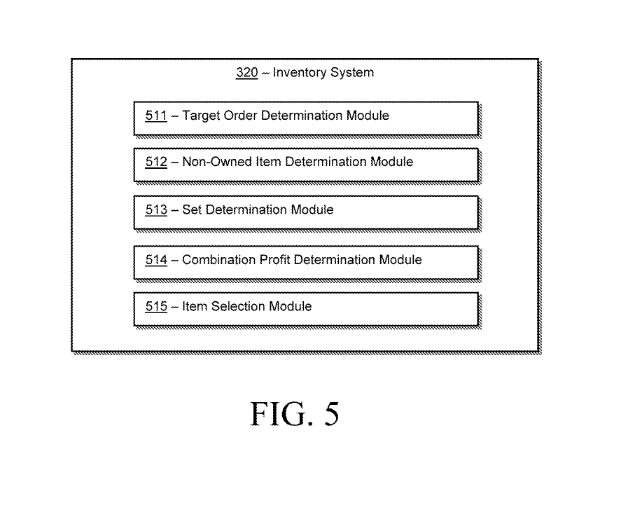

Turning ahead in the drawings, FIG. 5 illustrates a block diagram of inventory system 320, according to the embodiment shown in FIG. 3. Inventory system 320 is merely exemplary and is not limited to the embodiments presented herein. Inventory system 320 can be employed in many different embodiments or examples not specifically depicted or described herein. In some embodiments, certain elements or modules of inventory system 320 can perform various procedures, processes, and/or acts. In other embodiments, the procedures, processes, and/or acts can be performed by other suitable elements or modules.

In a number of embodiments, inventory system 320 can include a target order determination module 511. In certain embodiments, target order determination module 511 can perform block 401 (FIG. 4) of determining a target order set from historical order data. In some embodiments, inventory system 320 can include a non-owned item determination module 512. In certain embodiments, non-owned item determination module 512 can perform block 402 (FIG. 4) of determining, for each order of the target order set, a non-owned item combination (C). In various embodiments, inventory system 320 can include a set determination module 513. In certain embodiments, set determination module 513 can perform block 403 (FIG. 4) of determining a non-owned item combination set (S) and a split item set (I).

In many embodiments, inventory system 320 can include a combination profit determination module 514. In certain embodiments, combination profit determination module 514 can perform block 404 (FIG. 4) of determining, for each of the non-owned item combination (C), a combination profit (p_{C}). In various embodiments, inventory system 320 can include an item selection determination module 515. In certain embodiments, an item selection determination module 515 can perform block 405 (FIG. 4) of determining a selected set of the distinct items (T) that maximizes a payoff of the selected set of the distinct items (P(T)) and/or block 406 of solving an integer programming formulation.

Although limiting cross-channel splits has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders. As another example, the modules within inventory system 320 in FIG. 5 can be interchanged or otherwise modified.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of limiting cross-channel splits in a supply chain network based at least in part on an additional distinct item capacity (t) of a first channel in the supply chain network, the method being implemented at least partially via execution of computer instructions configured to run at one or more processing modules and configured to be stored at one or more non-transitory memory storage modules, the method comprising:
determining via the one or more processing modules a target order set from historical order data, the target order set comprising orders each having at least one first item that was fulfilled from the first channel and at least one second item that was fulfilled from a second channel in the supply chain network that is different from the first channel;
determining via the one or more processing modules, for each order of the target order set, a non-owned item combination (C) comprising distinct items (i) that were not fulfilled from the first channel when the order was fulfilled;
determining via the one or more processing modules a non-owned item combination set (S) and a split item set (I), wherein each of the non-owned item combinations (C) is a member of the non-owned item combination set (S), and each of the distinct items (i) in each of the non-owned item combinations (C) is a member of the split item set (I);
determining via the one or more processing modules, for each of the non-owned item combinations (C), a combination profit (p_{C}); and
determining via the one or more processing modules a selected set of the distinct items (T) that maximizes a payoff of the selected set of the distinct items (P(T)), wherein:
$$P ( T ) = {\sum }_{C ∈ S and C ⊆ T} {p}_{C} ,$$
the selected set of the distinct items (T) is a subset of the split item set (I), and a quantity of the distinct items in the selected set of the distinct items (T) is less than or equal to the additional distinct item capacity (t).

2. The method of claim 1, wherein:
determining via the one or more processing modules the selected set of the distinct items (T) comprises solving via the one or more processing modules an integer programming formulation comprising:
$$maximize {\sum }_{C ∈ S} {p}_{C} \times Y ( C )$$
$$subject to \text{:}$$
$${\sum }_{i ∈ I} X ( i ) \leq t$$
$$\vert C \vert \times Y ( C ) \leq {\sum }_{i ∈ C} X ( i ) for all C ∈ S$$
$$X ( i ) ∈ \{ 0 , 1 \} for all i ∈ I$$
$$Y ( C ) ∈ \{ 0 , 1 \} for all C ∈ S ,$$
wherein:
X(i) is a binary representation of whether each of the distinct items (i) is in the selected set of the distinct items (T); and
Y(C) is a binary representation of whether all of the distinct items (i) in each of the non-owned item combinations (C) are in the selected set of the distinct items (T).

3. The method of claim 1 further comprising:
relocating a supply for each of the distinct items (i) in the selected set of the distinct items (T) to the first channel.

4. The method of claim 1, wherein:
the historical order data comprises online orders for the past 60 days.

5. The method of claim 1, wherein:
the combination profit (p_{C}) for each of the non-owned item combinations (C) is a quantity of the orders of the target order set having the non-owned item combinations (C).

6. The method of claim 1, wherein:
the combination profit (p_{C}) for each of the non-owned item combinations (C) is a profit to be gained by adding each of the distinct items (i) in the non-owned item combinations (C) to the first channel.

7. The method of claim 6, wherein:
the combination profit (p_{C}) for each of the non-owned item combinations (C) is based at least in part on a packaging cost of the distinct items (i) in the non-owned item combinations (C).

8. The method of claim 6, wherein:
the combination profit (p_{C}) for each of the non-owned item combinations (C) is based at least in part on an individual shipping cost of the distinct items (i) in non-owned item combinations (C).

9. The method of claim 6, wherein:
the combination profit (p_{C}) for each of the non-owned item combinations (C) is based at least in part on a bulk shipping cost of the distinct items (i) in non-owned item combinations (C).

10. The method of claim 1, wherein
the first channel in the supply chain network is an owned distribution center.

11. The method of claim 1, wherein:
the second channel in the supply chain network is a vendor channel.

12. A system for limiting cross-channel splits in a supply chain network based at least in part on an additional distinct item capacity (t) of a first channel in the supply chain network, the system comprising:
one or more processing modules; and
one or more non-transitory memory storage modules storing computing instructions configured to run on the one or more processing modules and perform the acts of:
determining via the one or more processing modules a target order set from historical order data, the target order set comprising orders each having at least one first item that was fulfilled from the first channel and at least one second item that was fulfilled from a second channel in the supply chain network that is different than the first channel;
determining from the one or more processing modules, for each order of the target order set, a non-owned item combination (C) comprising distinct items (i) that were not fulfilled from the first channel when the order was fulfilled;
determining via the one or more processing modules a non-owned item combination set (S) and a split item set (I), wherein each of the non-owned item combinations (C) is a member of the non-owned item combination set (S), and each of the distinct items (i) in each of the non-owned item combinations (C) is a member of the split item set (I);
determining via the one or more processing modules, for each of the non-owned item combinations (C), a combination profit (p_{C}); and
determining via the one or more processing modules a selected set of the distinct items (T) that maximizes a payoff of the selected set of the distinct items (P(T)), wherein:
$$P ( T ) = {\sum }_{C ∈ S and C ⊆ T} {p}_{C} ,$$
the selected set of the distinct items (T) is a subset of the split item set (I), and a quantity of the distinct items in the selected set of the distinct items (T) is less than or equal to the additional distinct item capacity (t).

13. The system of claim 12, wherein:
determining via the one or more processing modules the selected set of the distinct items (T) comprises solving via the one or more processing modules an integer programming formulation comprising:
$$maximize {\sum }_{C ∈ S} {p}_{C} \times Y ( C )$$
$$subject to \text{:}$$
$${\sum }_{i ∈ I} X ( i ) \leq t$$
$$\vert C \vert \times Y ( C ) \leq {\sum }_{i ∈ C} X ( i ) for all C ∈ S$$
$$X ( i ) ∈ \{ 0 , 1 \} for all i ∈ I$$
$$Y ( C ) ∈ \{ 0 , 1 \} for all C ∈ S ,$$
wherein:
X(i) is a binary representation of whether each of the distinct items (i) is in the selected set of the distinct items (T); and
Y(C) is a binary representation of whether all of the distinct items (i) in each of the non-owned item combinations (C) are in the selected set of the distinct items (T).

14. The system of claim 12, wherein:
the historical order data comprises online orders for the past 60 days.

15. The system of claim 12, wherein:
the combination profit (p_{C}) for each of the non-owned item combinations (C) is a quantity of the orders of the target order set having the non-owned item combinations (C).

16. The system of claim 12, wherein:
the combination profit (p_{C}) for each of the non-owned item combinations (C) is a profit to be gained by adding each of the distinct items (i) in the non-owned item combinations (C) to the first channel.

17. The system of claim 16, wherein:
the combination profit (p_{C}) for each of the non-owned item combinations (C) is based at least in part on a packaging cost of the distinct items (i) in the non-owned item combinations (C).

18. The system of claim 16, wherein:
the combination profit (p_{C}) for each of the non-owned item combinations (C) is based at least in part on an individual shipping cost of the distinct items (i) in the non-owned item combinations (C).

19. The system of claim 16, wherein:
the combination profit (p_{C}) for each of the non-owned item combinations (C) is based at least in part on a bulk shipping cost of the distinct items (i) in the non-owned item combinations (C).

20. The system of claim 12, wherein:
the first channel in the supply chain network is an owned distribution center; and
the second channel in the supply chain network is a vendor channel.
